(19) United States
(12) Patent Application Publication
(10) Pub. No.: US 2012/0172067 A1
(43) Pub. Date: Jul. 5, 2012

(54) SYSTEM AND METHOD FOR VERIFYING A SENDER OF AN SMS TEXT MESSAGE

(75) Inventor: Matthew J. Gillin, Villanova, PA (US)

(73) Assignee: RELAY HOLDINGS, LLC, Radnor, PA (US)

(21) Appl. No.: 12/983,785

(22) Filed: Jan. 3, 2011

(51) Int. Cl. H04W 4/14

(52) U.S. Cl. 455/466

(57) ABSTRACT

A system and method are provided for verifying a sender of an SMS text message. The SMS text message may be validated by texting or calling the verification server from any phone and providing the unique code as a validation code, by texting or calling from the recipient mobile phone (no unique code is needed as the phone number may be linked to the sent message), or by logging in to an in-box of the verification server where valid messages to the recipient are logged. For example, the verification server receives the received unique code from the recipient for verification by receiving an SMS text message including the received unique code, receiving the unique code from the recipient via an Internet browser, receiving the unique code from the recipient via a phone call, or receiving a trusted authentication short code based on the unique code. The verification server may also receive from the sender a copy of the SMS text message and the recipient's phone number when the SMS text message is sent to the recipient. Then, when the verification server receives a verification request from the recipient to verify the sender, the unique code received by the recipient and/or the recipient's mobile phone number may be compared to the unique code and/or recipient phone number stored with the message received by the verification server from the sender. The verification may include the verification server receiving the last SMS text message sent by the message sender and allowing the message recipient to verify the message sender by accessing the verification server by logging into the verification server or by calling in through an interactive voice response (IVR) unit to check for the presence of the last SMS text message from the message sender to the recipient.

### FIELD OF THE INVENTION

The present invention relates to a system and method for verifying a sender of an SMS text message and, more particularly, to a system and method for sending with an SMS text message a unique code that uniquely identifies the SMS text message, whereby the recipient of the SMS text message can validate whether the received SMS text message corresponds to a sent SMS text message from a valid sender.

### BACKGROUND

SMS text messaging is a rapidly growing means of communications. Recently, the ubiquity of SMS text messaging has been tapped into to facilitate business communications as well as private communications. Numerous business applications have been developed that facilitate the use of SMS text messages to settle payment and to transfer other valuable information. Unfortunately, as with email, the source of SMS text messages may be spoofed, thereby misleading the recipient as to the source of the SMS text message and opening the recipient to unsolicited messages and phishing scams. While spam filtering techniques have been developed to authenticate the source of emails, Applicant is not aware of any techniques for verifying and authenticating the source of SMS text messages. Such techniques must be developed before SMS text messages may be widely accepted in business applications, particularly in applications requiring payment. The present invention addresses this need in the art.

### SUMMARY

The above-referenced need in the art is addressed by providing a system and method for verifying a sender of an SMS text message by providing a unique code uniquely identifying each SMS text message to be sent by a message sender, sending an SMS text message with the unique code associated therewith to a recipient, receiving a validation request at a verification server with the SMS text message and/or with a last message sent by the SMS text message sender, and verifying that the message is in fact the SMS text message sent from the SMS text message sender. The SMS text message may be validated by texting or calling the verification server from any phone and providing the unique code as a validation code, by texting or calling from the recipient mobile phone (no phone is needed as the phone number may be linked to the sent message), or by logging in to an in-box of the verification server where valid messages to the recipient are logged. In an exemplary embodiment, the verification server receives the received unique code from the recipient for verification by receiving an SMS text message including the received unique code, receiving the unique code from the recipient via an Internet browser, receiving the unique code from the recipient via a phone call, or receiving a trusted authentication short code based on the unique code. The verification server may also receive from the sender a copy of the SMS text message and the recipient's phone number when the SMS text message is sent to the recipient. Then, when the verification server receives a verification request from the recipient to verify the sender, the unique code received by the recipient and/or the recipient's mobile phone number may be compared to the unique code and/or recipient phone number stored with the message received by the verification server from the sender. The verification may include the verification server receiving the last SMS text message sent by the message sender and allowing the message recipient to verify the message sender by accessing the verification server by logging into the verification server or by calling in through an interactive voice response (IVR) unit to check for the presence of the last SMS text message from the message sender to the recipient.

The unique code sent with the SMS text message may be generated in advance by sending a message file from the message sender to the verification server and providing the SMS text messages back to the message sender from the verification server with unique codes assigned to each SMS text message for each recipient. The verification server may receive a copy of all SMS text messages sent by the message sender and archive the SMS text messages. In such case, the recipient may check that a received SMS text message is valid by checking whether the received SMS text message has been archived by the verification server. The verification server may also provide a verification response to the message recipient including a certificate verifying that the SMS text message is legitimate.

In exemplary embodiments, the step of the sender sending an SMS text message with the unique code associated therewith includes sending the SMS text message with the unique code to an SMS aggregator and the SMS aggregator providing the SMS text message with the unique code to the recipient. On the other hand, the unique code may be associated with each SMS text message by the verification server and the SMS text message and associated code may be sent by via the verification server to the recipient.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Exemplary embodiments of the invention will be described in connection with the associated figures, of which:

FIG. 1 illustrates an example embodiment of a system for verifying a sender of an SMS text message in accordance with the invention.

FIG. 2 illustrates an example embodiment of a method for SMS verification implemented on a server adapted for SMS verification in accordance with the invention.

FIG. 3 illustrates an example embodiment of a method for SMS verification when an SMS aggregator is used to aggregate SMS text messages for transmission to one or more recipients in accordance with the invention.

### DETAILED DESCRIPTION OF ILLUSTRATIVE EMBODIMENTS

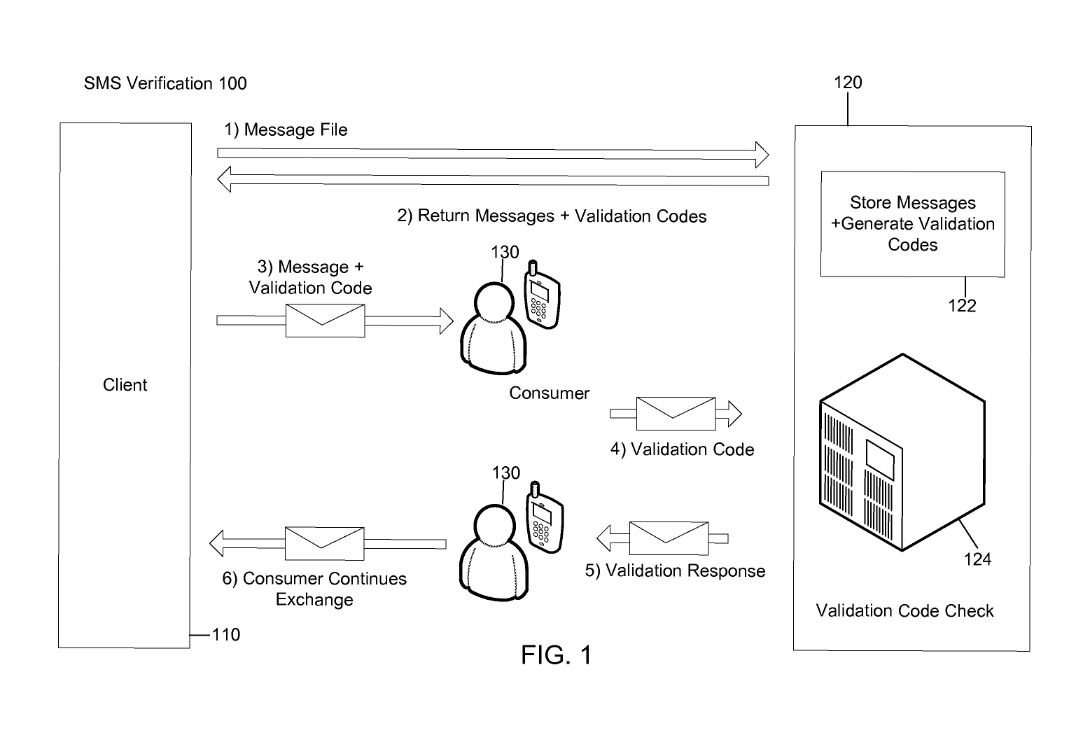

A detailed description of illustrative embodiments of the present invention will now be described with reference to FIGS. 1-3. Although this description provides a detailed example of possible implementations of the present invention, it should be noted that these details are intended to be exemplary and in no way delimit the scope of the invention.

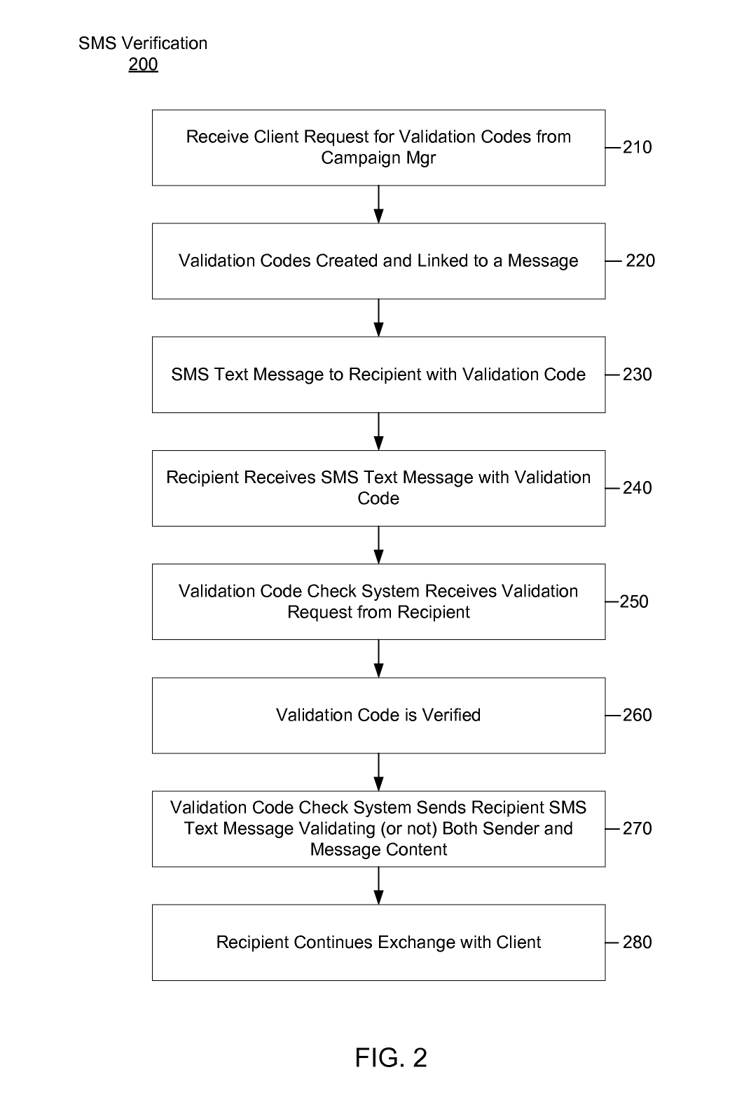

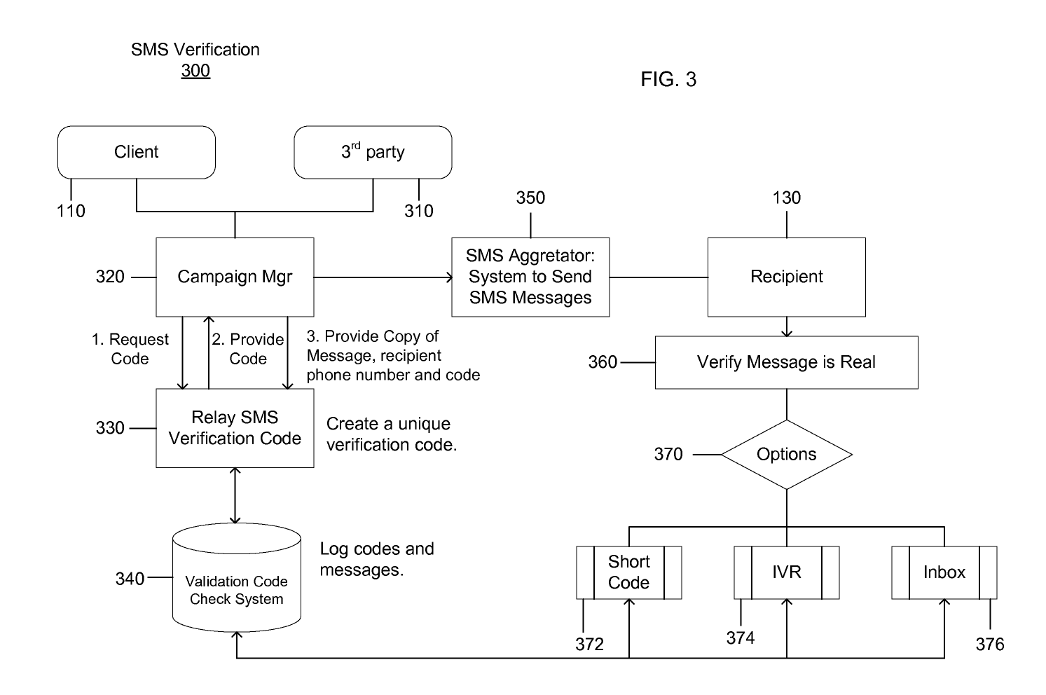

FIG. 1 illustrates an example embodiment of a system for verifying a sender of an SMS text message as a “trusted” source. As illustrated, SMS verification system 100 enables a client (SMS text message provider) 110 to receive validation codes from a validation code check system 120 including a message store 122 that stores messages and corresponding generated validation codes and a validation server 124 that checks the validation codes stored in the message store 122 against validation codes provided to the validation server 124 by the recipient of the respective SMS text message. In an exemplary embodiment, prior to sending one or more SMS text messages, the client 110 may send a message file of the one or more SMS text messages to the validation code check system at (1) for assignment of unique codes for each SMS text message to be transmitted. These unique validation codes are returned to the client 110 along with the SMS text messages to be transmitted at (2). At (3), the SMS text messages with unique validation code associated therewith are transmitted to the message recipient 130. If the message recipient desires to verify the accuracy of the sender of any received SMS text messages, the message recipient 130 at (4) forwards the unique validation code to the validation server 124 for verification. The validation server 124 checks the received unique validation code received from the message recipient 130 against the message store 122 to see if the unique validation code has been stored. If not, the validation server 124 indicates at (5) that the unique validation code, and hence the transmitted message, may be untrustworthy as possibly from an invalid source. On the other hand, if the unique validation code is present in the message store 122, the validation server 124 may indicate at (5) that the unique validation code, and hence the transmitted message, is from a trustworthy source. Additionally, the validation response at (5) could include the identity of the actual provider of the SMS text message received by message recipient 130. If the message recipient 130 is thereby satisfied that the SMS text message has been transmitted by a reliable source, then the SMS text message exchange may continue at (6). Further details of the operation of the SMS text message sender verification in accordance with the invention will be described in further detail below with respect to FIGS. 2 and 3.

Those skilled in the art will appreciate that the validation code check system 120 may include a computing environment implemented by a computer, a mainframe, a server, or the like. According to the illustrated embodiment, the computing environment includes validation server 124 having hardware components and/or software components such that the resulting computing environment may be used to execute applications such as internet applications, operating systems, server applications, client applications, database applications, or the like. For example, the computing environment on validation server 124 may be used to execute software application programs implementing the methods described below with respect to FIGS. 2 and 3.

In an example embodiment, the validation server 124 of the validation code check system 120 includes a processor that may be in operative communication with an instruction memory (both not shown) with instructions for implementing an operating system and application programs for implementing the validation code checking techniques of the invention. The processor may include a standardized processor, a specialized processor, a microprocessor, or the like. The processor executes instructions including, for example, instructions for creating unique validation codes, sending electronic communications, or any other suitable instruction, which will be described in more detail below.

The instruction memory of validation server 124 stores the instructions that may be executed by the processor of the validation server 124. The instruction memory may include computer readable storage media in the form of volatile and/or nonvolatile memory such as random access memory (RAM), read only memory (ROM), cache, Flash memory, a hard disk, or any other suitable storage component. In one embodiment, the instruction memory may be a separate component in communication with the processor of the validation server 124, while in another embodiment, the instruction memory may be integrated into the processor of validation server 124.

As shown in FIG. 1, the validation code check system 120 may be in communication with client 110 via communication links that may be a wired connection including, for example, a USB connection, a Firewire connection, an Ethernet cable connection, or the like and/or a wireless connection such as a wireless 802.11b connection, a radio connection, a cell phone connection, or the like.

FIG. 2 illustrates an example embodiment of a method for SMS verification implemented on validation server 124 adapted for SMS verification in accordance with the invention. FIG. 2 represents methods that may be implemented in software application programs on validation server 124, for example. As indicated in FIG. 2, the SMS verification method 200 implemented on verification server 124 in an exemplary embodiment includes the steps of assigning the unique validation codes to the SMS text messages of the client 110 and checking the validation codes provided by the message recipient against the stored validation codes. This is accomplished in the exemplary embodiment by receiving the client's request for validation codes from the validation code check system 120 at 210 and providing unique validation codes for each individual or group of SMS text messages to the client 110 at 220. The client 110 directly, or via the validation code check system 120, then sends the SMS text message with the assigned unique validation code to the intended message recipient 130 at 230 and the intended message recipient receives the SMS text message with assigned validation code at 240. If the message recipient 130 desires to verify that the sender of the received SMS text message is trustworthy or a known person, the message recipient sends the validation code to the validation code check system 120 where the validation code is received at 250. At 260, the validation server 124 checks the received validation code against the validation codes stored in message store 122 to determine if the validation code is present and, if so, whether the message matches the sent message and message sender. If the validation code is not found, the validation server 124 indicates to the message recipient 130 at 270 that the unique validation code, and hence the transmitted message, may be untrustworthy as possibly from an invalid source. On the other hand, if the unique validation code is present in the message store 122, the validation server 124 may indicate to the message recipient 130 at 270 that the unique validation code, and hence the transmitted message, is from a trustworthy source. Additionally, the validation response at 270 could include the identity of the actual provider of the SMS text message received by message recipient 130. If the message recipient 130 is thereby satisfied that the SMS text message has been transmitted by a reliable source, then the message recipient 130 continues the SMS text message exchange with the client (sender) 110 at 280.

FIG. 3 illustrates an example embodiment of a method for SMS verification when an SMS aggregator is used to aggregate SMS text messages for transmission to one or more recipients in accordance with the invention. As illustrated in FIG. 3, the client 110 and/or a third party sender arranges with a campaign manager 320 to send SMS text messages with verification. To arrange to send SMS text messages with verification, the campaign manager 320 requests unique SMS verification codes from the SMS verification code providing unit 330 for each SMS text message to be sent. These codes are provided to the campaign manager 320 by the SMS verification code providing unit 330 for use by the campaign manager 320 in sending verifiable SMS text messages. The campaign manager 320 may then create one or more SMS text messages to which unique validation codes from the SMS verification code providing unit 330 are assigned. A copy of the message, the recipient's phone number, and the unique verification code for that message are provided to the SMS verification code providing unit 330 which, in turn, provides this information to the verification code check system 340 for logging of the messages and associated verification codes and recipient phone numbers. The generated SMS text message(s) with verification codes are also sent to the recipient 130 via SMS aggregator 350 in a conventional fashion. Upon receipt of the SMS text message, the recipient 130 may determine at 360 to use the verification feature of the invention to validate that the received message is from a trustworthy or a known message source (and is thus a “real” message).

Several verification options are offered at 370. For example, the recipient may send a trusted authentication short code SMS text message including the received unique code from any phone at 372 to the validation server 124. Those skilled in the art will further appreciate that the unique code need not be provided if the verification request is from the recipient's mobile phone, as the recipient's mobile phone number is stored with the sent message and the unique code. In addition, the recipient may verify the received SMS text message by calling an interactive voice response (IVR) system at 374 to initiate the validation process at the validation server 124 by providing the received unique code to the IVR system. Those skilled in the art will also appreciate that the unique code need not be provided for this option either if the verification request is from the recipient's mobile phone number stored with the sent message and the unique code. As a third option, the recipient may check at 376 an inbox of the validation server 124 that identifies the recent messages sent by the identified sender to the recipient and stored in the sent message log 340. The unique code may also be provided to the validation server 124 by the recipient via an Internet browser. In each of these cases, the request for validation is forwarded the validation code check system 340 and compared to the log data. An appropriate validation response is then returned to the recipient as described above with respect to FIGS. 1 and 2. For example, an electronic verification certificate may be provided to the recipient, as desired.

Those skilled in the art also will readily appreciate that these and many additional modifications are possible in the exemplary embodiment without materially departing from the novel teachings and advantages of the invention. For example, the client system 110 may have a mechanism for generating validation codes without requesting such codes from the SMS verification code unit 330. In such case, the generated codes would need to be stored at the client side with the sent messages or provided to the log system with the corresponding messages for protected access by the validation code check system 340. Accordingly, any such modifications are intended to be included within the scope of this invention as defined by the following exemplary claims.

What is claimed:

1. A method of verifying a sender of an SMS text message, comprising the steps of:
providing a unique code uniquely identifying each SMS text message to be sent by a message sender;
logging SMS text messages with associated mobile phone numbers and unique codes in a validation code check memory; and
upon the message sender sending an SMS text message with said unique code associated therewith to a recipient, a verification server receiving a validation request from the recipient including the unique code received and/or a validation request from the recipient's mobile phone number and verifying against said validation code check memory that a SMS text message received by the recipient is in fact the SMS text message sent from the SMS text message sender.

2. The method as in claim 1, wherein the verification server receives the received unique code from the recipient for verification by at least one of receiving an SMS text message including the received unique code, receiving the unique code from the recipient via an Internet browser, receiving the unique code from the recipient via a phone call, and receiving a trusted authentication short code based on said unique code.

3. The method as in claim 1, wherein the verification server receives the last SMS text message sent by the message sender and allows the recipient to access the verification server to check for the presence of the last SMS text message from the message sender.

4. The method as in claim 1, further comprising the steps of the verification server receiving a message file from the message sender and the verification server providing the SMS text messages back to the message sender with unique codes assigned to each SMS text message for each recipient.

5. The method as in claim 1, further comprising the step of the verification server providing a verification response to the message recipient including a certificate verifying that the SMS text message is legitimate.

6. The method as in claim 1, wherein the SMS text message with said unique code is provided by the message sender to an SMS text message aggregator and said SMS text message aggregator provides said SMS text message with said unique code to said recipient.

7. The method as in claim 1, wherein the validation code check memory receives a copy of all SMS text messages sent by said message sender and archives said SMS text messages.

8. The method as in claim 7, wherein the verification server checks that a received SMS text message is valid by checking whether the received SMS text message has been archived in said validation code check memory.

9. A server programmed to enable a recipient of an SMS text message to verifying a sender of the received SMS message, said server including a processor that processes instructions for implementing the steps of:
providing a unique code uniquely identifying each SMS text message to be sent by a message sender;
logging SMS text messages with associated mobile phone numbers and unique codes in a validation code check memory; and
upon the message sender sending an SMS text message with said unique code associated therewith to a recipient, receiving a validation request from the recipient including the unique code received and/or a validation request from the recipient's mobile phone number and verifying against said validation code check memory that a SMS text message received by the recipient is in fact the SMS text message sent from the SMS text message sender.

10. The server of claim 9, wherein the processor receives the received unique code from the recipient for verification by at least one of receiving an SMS text message including the received unique code, receiving the unique code from the recipient via an Internet browser, receiving the unique code from the recipient via a phone call, and receiving a trusted authentication short code based on said unique code.

11. The server of claim 9, wherein the processor receives the last SMS text message sent by the message sender and allows the recipient to access the server to check for the presence of the last SMS text message from the message sender.

12. The server of claim 9, further comprising the processor receiving a message file from the message sender and the server providing the SMS text messages back to the message sender with unique codes assigned to each SMS text message for each recipient.

13. The server of claim 9, further comprising the processor providing a verification response to the recipient including an electronic verification certificate verifying that the SMS text message is legitimate.

14. The server of claim 9, wherein the validation code check memory r receives a copy of all SMS text messages sent by said message sender and archives said SMS text messages.

15. The server of claim 14, wherein the processor checks that a received SMS text message is valid by checking whether the received SMS text message has been archived in said validation code check memory.
